(19) United States
(12) Patent Application Publication
(10) Pub. No.: US 2008/0074754 A1
(43) Pub. Date: Mar. 27, 2008

(54) PLASTIC LENS

(75) Inventor: Kenichi SAKAMOTO, Saitama (JP)

Correspondence Address: YOUNG & THOMPSON, 745 SOUTH 23RD STREET, 2ND FLOOR, ARLINGTON, VA, 22202, US

(73) Assignee: FUJINON CORPORATION, SAITAMA (JP)

(21) Appl. No.: 11/857,464

(22) Filed: Sep. 19, 2007

(30) Foreign Application Priority Data
Sep. 22, 2006 (JP) 2006-257098

(51) Int. Cl. G02B 3/00

(52) U.S. Cl. 359/642

(57) ABSTRACT

A plastic lens comprises a lens portion and a flange portion which are cast as an integral piece by injection molding using separate molds. A positioning reference surface is formed as an integral part of the lens portion between the lens portion and the flange portion by a casting mold for forming the lens portion. When the plastic lens is installed in a lens barrel and adjusted in position, a fixture holds the plastic lens at the positioning reference surface.

### BACKGROUND OF THE INVENTION

1. Field of the Invention

The present invention relates to a plastic lens element having a flange portion and, more specifically, to a plastic lens element which is molded by the use of a split mold assembly comprising a lens portion split mold and a flange portion split mold.

2. Description of Related Art

As shown in FIG. 7, a plastic lens element 50 comprises an effective lens portion 51 functioning as an optical lens and a flange portion 52 surrounding the effective lens portion 51 which are formed as an integral piece. The plastic lens element 50 is installed in a lens barrel by holding the flange portion 52 directly by the lens barrel or through a lens holder. Typically, the plastic lens element 50 is formed by split and solidifying a molten resin into a mold cavity 58 formed in a split mold 57 which comprises a stationary mold half 55 and a movable mold half 57. The stationary mold half 55 comprises a lens portion mold half 59 and a flange portion mold half 61 which are separately provide. Similarly, the movable mold half 57 comprises a lens portion mold half 60 and a flange portion mold half 62 which are separately provided. Because the plastic lens element is formed by the split mold 57 comprising the stationary mold half 55 and the movable mold half 57 each of which comprises two discrete parts, namely a lens portion mold half and a flange portion mold half, it is not improvable that lens portion 51 has an optical axis out of line with a mechanical central axis of the flange portion 52. In the case where the optical axis of the lens portion 51 is in disagreement with the mechanical central axis of the flange portion 52, the plastic lens element 50 encounters the problem that the plastic lens element 50 installed in a lens barrel is not coaxial with respect to the lens barrel.

In order to avoid an occurrence of the problem, it is typical to carry out optical axis adjustment when installing the plastic lens element into a lens barrel. The optical axis adjustment is performed in such a way that is disclosed in, for example, Japanese Unexamined Patent Publication No. 2000-121902. Specifically, while the plastic lens element is kept in position in a lens barrel by holding the flange portion by a fixture, a deflection of the optical axis of the plastic lens element with respect to the central axis of the lens barrel is optically detected. Then, the plastic lens element is adjusted in position so as to remove the deflection and, thereafter, fixed in the lens barrel by an adhesive.

The optical axis adjustment is time consuming work due to delicate operation and causes a cost rise of a lens device due to a requirement of a precise fixture.

### SUMMARY OF THE INVENTION

It is therefore an object of the present invention to provide a plastic lens element which facilitates optical axis adjustment.

The foregoing object of the present invention is accomplished by a plastic lens element comprising a lens portion which is formed by a lens casting split mold and a flange portion surrounding the lens portion which is formed as an integral part of the lens portion by a flange casting split mold provided separately from the lens casting split mold. The plastic lens element comprises a first lens surface forming an entrance aperture of the lens portion, a second lens surface forming an effective exit aperture of the lens portion, and a positioning surface serving as a reference surface for adjusting an optical axis of the plastic lens element with respect to a central axis of a lens barrel in which the plastic lens element is installed, wherein the positioning surface is formed as an integral part of the lens portion formed between the lens portion and the flange portion by the lens casting split mold.

The positioning surface preferably comprises a beveled annular surface continuing from the second lens surface and may further comprise a cylindrical surface continuing from the beveled annular surface.

According to an embodiment, because the reference surface is formed by the same mold as for the lens portion, the optical axis of the lens portion is precise in position with respect to the reference surface. Further, because the plastic lens element can be installed in a lens barrel on the basis of the reference surface, a deflection of the optical axis of the plastic lens element with respect to the central axis of the lens barrel is made small, so that the optical axis adjustment is facilitated and simplified or dispensed.

### BRIEF DESCRIPTION OF THE DRAWINGS

The foregoing and other objects and features of the present invention will be clearly understood from the following detailed description when reading with reference to the accompanying drawings in which same or similar parts or portions are denoted by the same reference numerals for avoiding repetitive descriptions, and wherein:

FIG. 1 is a cross-sectional view of a lens barrel in which a plastic lens element according to an embodiment is installed;

FIG. 2 is a cross-sectional view of a split mold assembly for molding the plastic lens element shown in FIG. 1;

FIG. 3 is a cross-sectional view of the plastic lens element shown in FIG. 1 which is supported by a fixture;

FIG. 4 is a cross-sectional view of a plastic lens element according to another embodiment;

FIG. 5 is a cross-sectional view of a split mold assembly for molding the plastic lens element shown in FIG. 4;

FIG. 6 is a cross-sectional view of the plastic lens element shown in FIG. 4 which is supported by a fixture;

FIG. 7 is a cross-sectional view of a prior art plastic lens element; and

FIG. 8 is a cross-sectional view of a split mold assembly for molding the prior art plastic lens element shown in FIG. 7.

### DETAILED DESCRIPTION OF THE PREFERRED EMBODIMENTS

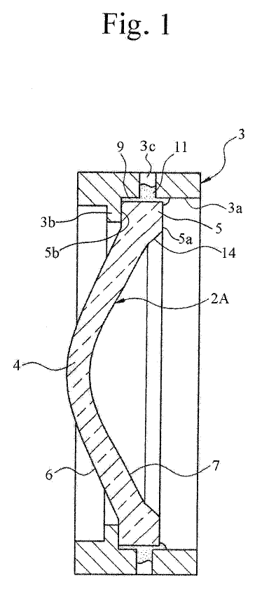

Referring to the accompanying drawings in detail and, in particular, to FIG. 1 showing a plastic lens element 2A according to an embodiment installed in a cylindrical lens barrel 3, the plastic lens element 2 comprises a lens portion 4 and an annular flange portion 5 surrounding the lens portion 4 which are formed as an integral piece. The lens portion 4 has a convex front or first lens surface 6 for forming an entrance aperture thereof and a concave rear or second lens surface 7 for forming an effective exit aperture thereof. The flange portion 5 has a rear surface 5a and a front working face 5b. The plastic lens element 2A is provided with an beveled annular shoulder 14 formed between the rear surface 5a of the flange portion 5 and the concave rear lens surface 7 of the lens portion 4 and out of an effective aperture area of the lens portion 4. The beveled annular shoulder 14 serves as a reference surface for axial positioning of the plastic lens element 2A with respect to the lens barrel 3 and has no effect on an optical function of the lens portion 4. The lens barrel 3 has an inner annular flange 3b for positioning the plastic lens element 2A in an axial direction and a plurality of radial bores 3c formed in a shell thereof at regular angular intervals. The plastic lens element 2A is installed in the lens barrel 3 and fixed to an inner wall 3a of the lens barrel 3 by an adhesive 11 filled in a circumferential clearance 9 between the flange portion 5 of the plastic lens element 2A and the inner wall 3a of the lens barrel 3 through the radial bores 3c.

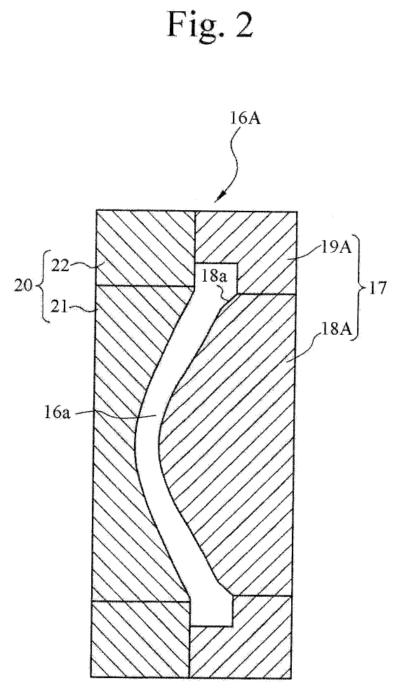

Referring to FIG. 2 showing a split mold assembly 16A for injection molding the plastic lens element 2A, the split mold assembly 16A comprises a stationary mold half 17 and a movable mold half 20 between which a mold cavity 16a is formed. The movable mold half 20 is movable between a clamped position (shown in FIG. 2) in which the movable mold half 20 is clamped down to the stationary mold half 17 and a split position in which the movable mold half 20 is split apart from the stationary mold half 17. The stationary mold half 17 comprises a lens portion mold half 18A and a flange portion mold half 19A which are separately provided. Similarly, the movable mold half 20 comprises a lens portion mold half 21 and a flange portion mold half 22 which are separately provided. The lens portion mold half 18A of the stationary mold half 17 has a beveled corner 18a for forming the beveled annular surface 14 of the plastic lens element 2A. Because the lens portion 4 and the beveled annular shoulder 14 are cast in one integral body by the split mold assembly 16A, geometrical position of the beveled annular shoulder 14 with respective to the optical axis of the lens portion 4 is highly accurate.

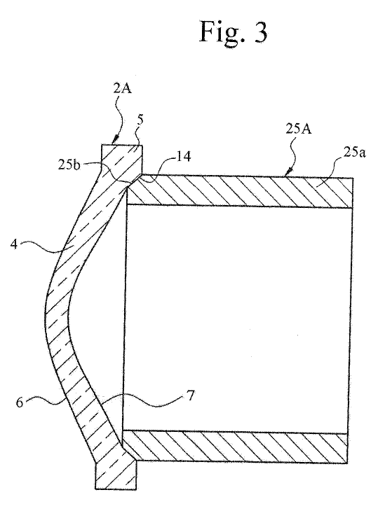

FIG. 3 shows the plastic lens element 2A injection molded in the split mold assembly 16A before installation into the lens barrel 3 (see FIG. 1). In this state, the plastic lens element 2A is held by, for example, a cylindrical fixture 25A comprising a cylindrical shell 25a which has a beveled annular corner 25b in conformity in shape with the beveled annular shoulder 14 of the plastic lens element 2A. The fixture 25A is desirably adapted to stick fast to the beveled annular shoulder 14 of the plastic lens element 2A at the beveled annular corner 25b by electrostatic sticking or vacuum sticking so as thereby to firmly hold the plastic lens element 2A. The fixture 25A is capable of coaxially holding the plastic lens element 2A with high accuracy through the beveled annular corner 25b thereof which is in conformity in shape with the beveled annular shoulder 14 of the plastic lens element 2A.

The plastic lens element 2A held by the fixture 25A is inserted into the lens barrel 3 until the front working face 5b is brought into contact to the inner annular flange 3b. Then, after carrying out adjustment of the optical axis of the plastic lens element 2A held by the fixture 25A and inserted into the lens barrel 3 to bring the optical axis of the plastic lens element 2A in line with the geometrical central axis of the lens barrel 3, an adhesive 11 is filled in the circumferential clearance 9 between the flange portion 5 of the plastic lens element 2A and the inner wall 3a of the lens barrel 3 through the radial bores 3c so as thereby to fix the plastic lens element 2A to the lens barrel 3. In this instance, it is enabled to save time spent on the optical axis adjustment by keeping the fixture 25A positioned coaxially in the lens barrel 3 as precisely as possible.

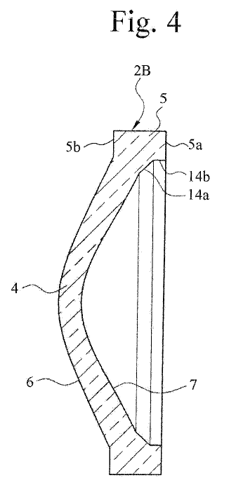

FIG. 4 shows a plastic lens element 2B according to another embodiment, the plastic lens element 2B comprises a lens portion 4 and an annular flange portion 5 surrounding the lens portion 4 which are formed as an integral piece. The lens portion 4 has a convex front or first lens surface 6 and a concave rear or second lens surface 7. The flange portion 5 has a front working face 5b and a rear surface 5a. The plastic lens element 2B is provided with a beveled annular shoulder 14a and a straight cylindrical shoulder 14b continuing from an annular edge of the beveled annular shoulder 14a which are formed between the rear surface 5a of the flange portion 5 and the concave rear lens surface 7 of the lens portion 4 and out of an effective aperture area of the lens portion 4.

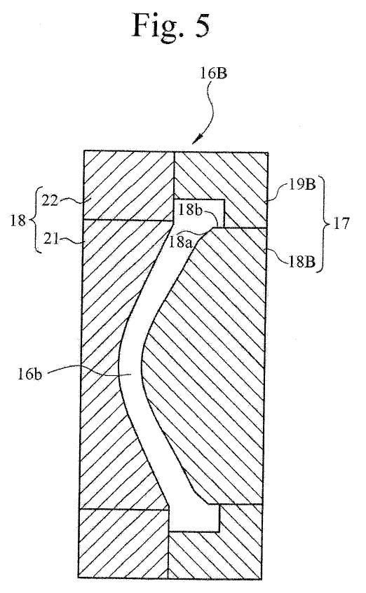

FIG. 5 shows a split mold assembly 16B for injection molding the plastic lens element 2B, the split mold assembly 16B comprises a stationary mold half 17 and a movable mold half 18 between which a mold cavity 16b is formed. The movable mold half 18 is movable between a clamped position (shown in FIG. 5) in which the movable mold half 18 is clamped down to the stationary mold half 17 and a split position in which the movable mold half 18 is split apart from the stationary mold half 17. The stationary mold half 17 comprises a lens portion mold half 18B and a flange portion mold half 19B which are separately provided. Similarly, the movable mold half 18 comprises a lens portion mold half 21 and a flange portion mold half 22 which are separately provided. The lens portion mold half 18B of the stationary mold half 17 has a beveled corner 18a for forming the beveled annular surface 14a and a cylindrical wall 18b forming the straight cylindrical shoulder 14b. Because the lens portion 4 and the beveled annular shoulder 14a are cast in one integral body by the split mold assembly 16B, the beveled annular shoulder 14a is accurately positioned with respective to the optical axis of the lens portion 4.

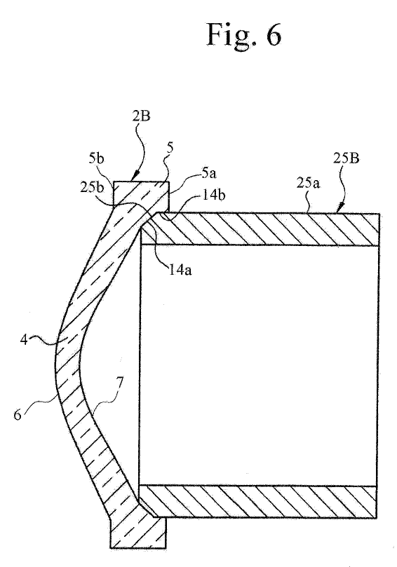

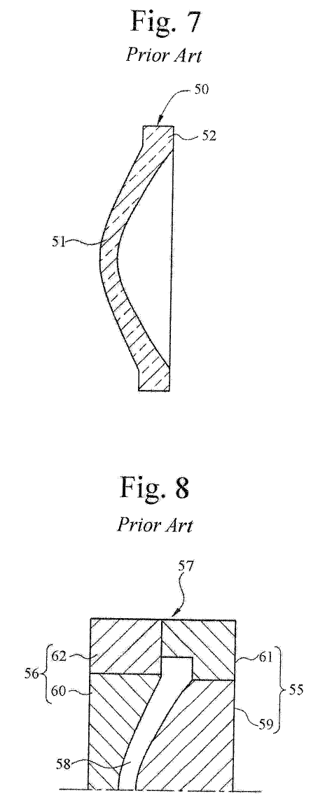

FIG. 6 shows the plastic lens element 2B held by a cylindrical fixture 25B. The fixture 25B comprises a cylindrical shell 25a having substantially the same outer diameter as the inner diameter of the cylindrical shoulder 14b and a beveled annular corner 25b in conformity in shape with the beveled annular shoulder 14a of the plastic lens element 2B. Since there is formed a fitting structure between the fixture 25B and the cylindrical shoulder 14b of the flange portion 5, the fixture 25B is capable of firmly holding the plastic lens element 2B as well as capable of coaxially holding the plastic lens element 2B with high accuracy through the beveled annular corner 25b thereof.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

What is claimed is:

1. A plastic lens element comprising a lens portion which is formed by a lens casting split mold and a flange portion surrounding the lens portion which is formed as an integral part of the lens portion by a flange casting split mold provided separately from said lens casting split mold, said plastic lens element comprising:
a first lens surface forming an entrance aperture of said lens portion;
a second lens surface forming an effective exit aperture of said lens portion; and
a positioning surface serving as a reference surface for adjusting an optical axis of said plastic lens element with respect to a central axis of a lens barrel in which said plastic lens element is installed;
wherein said positioning surface is formed as an integral part of said lens portion formed between said lens portion and said flange portion by said lens casting split mold.

2. The plastic lens element as defined in claim 1, wherein said positioning surface comprises a beveled annular surface continuing from said second lens surface.

3. The plastic lens element as defined in claim 1, wherein said positioning surface further comprises a cylindrical surface continuing from said beveled annular surface.
